(19) United States
(12) Patent Application Publication
(10) Pub. No.: US 2011/0215608 A1
(43) Pub. Date: Sep. 8, 2011

(54) Pickup truck bed extender

(76) Inventor: Jesse Van Jackson, Wilmington, NC (US)

(21) Appl. No.: 12/660,622

(22) Filed: Mar. 2, 2010

(51) Int. Cl. B62D 33/08

(52) U.S. Cl. 296/26.11

(57) ABSTRACT

A truck bed extender is described for use with a pickup truck having a bed with a bed floor, opposed side walls along each side of the bed floor and a tailgate hinged at the rear of the bed floor. The bed extender includes mounting brackets attached to either the bed side walls or bed floor adjacent the tailgate. First and second tubular base sections are pivotally attached at their proximal ends to the brackets. First and second tubular telescoping sections are attached to the base sections. The telescoping sections have transverse arms with horizontal openings at their distal ends. A support bar extends through the openings in the arms. The bed extender is easily installed and uninstalled, and fits truck beds of different widths.

### BACKGROUND OF THE INVENTION

(1) Field of the Invention

The present invention relates to an apparatus for providing a greater load-bearing surface for a pickup truck bed, and in particular to a pickup truck bed extender that can be quickly attached and removed from a pickup truck bed.

(2) Description of the Prior Art

The beds of most pickup trucks are shorter than many items, such as lumber, plywood, ladders, canoes, and other length items that the user needs to transport. As a result, the item extends beyond the back of the pickup truck bed, even with the tailgate in its lowered, horizontal position. Many items extend so far beyond the back of the bed that there is a risk of the item tipping and falling from the bed. In addition, many items require support near the rear end to prevent breakage.

This problem has been long recognized and numerous designs of devices known as truck bed extenders have been proposed. Generally, a conventional truck bed extender is comprised of a lower frame section or base that is attached, e.g., by bolting, to the pickup bed floor, and an upper frame section that is slidably attached to the lower frame section in a manner permitting rearward movement of the upper frame section beyond the rear of the pickup bed, thereby providing a carrying surface of greater length.

These conventional truck bed extenders, while somewhat useful for their designed function, have several disadvantages. Most bed extenders are designed for permanent installation in the truck bed, or are so difficult to remove that they are normally left in the truck bed. When not used as bed extenders, these devices take up a significant percentage of the carrying space available in the truck bed, diminishing the pickup truck's utility.

Pickup truck beds are available in a variety of widths. Many existing truck bed extenders are designed for use with a truck bed of a given dimension. As a result, it is not possible to move the bed extender to a truck bed of a different size. Commercially, manufacture and inventorying of bed extenders of different sizes is required to meet the requirements of different purchasers.

Therefore, there is a continuing need for a pickup truck bed extender that can be quickly installed in and removed from a pickup truck bed, even without the use of tools. There is also a need for a pickup truck bed that can be easily adjusted to fit different size pickup truck beds.

### SUMMARY OF THE INVENTION

Generally, deficiencies of prior art truck bed extenders, including the above deficiencies, are addressed by the present invention, designed for quick and easy installation and removal from a pickup truck bed. As used herein, a pickup truck bed includes a bed floor with front and rear ends and parallel sides; opposed, parallel, vertical side walls attached at the sides of the bed floor; a vertical front wall attached at the front end of the bed floor; and a tail gate having a bottom edge hinged at the rear end of the bed floor. The tail gate is moveable between a closed, vertical orientation and an open, horizontal orientation.

Unlike prior art bed extenders, the present bed extender is attached with opposed mounting brackets that are secured to the bed side walls or bed floor adjacent the junctures of the walls and bed floor and adjacent the rear of the bed floor. The mounting brackets include post receiving bores that are transverse to the longitudinal axis of the bed floor.

The present bed extender further includes first and second tubular base sections with proximal ends having horizontal, transverse posts that are slidable into the mounting bracket bores, and distal end; telescoping tubular sections with proximal ends slidable onto the base tubular sections, and distal ends; and a transverse support bar attachable to the distal ends of the telescoping sections. The bed extender may also include tailgate attachment brackets to releasibly secure the bed extender to the tailgate.

The base and telescoping sections also include locking means to secure the sections together at a desired extension. For example, the base tubular sections may include one or more holes, while the telescoping sections also include one or more mating holes, with a hole in the telescoping section being selectively alignable with a hole in the base section to allow insertion of a pin or other locking means through the aligned holes to secure the telescoping section relative to the base section.

The distal ends of the telescoping sections include transverse, horizontal openings sized to receive the support bar. The support bar and telescoping sections also include locking means to secure the support bar to the telescoping sections. For example, alignable holes in the bar and telescoping sections may be included for insertion of a pin or other locking member. The locking member may be permanently attached to one of the sections and spring loaded for easy assembly. Preferably, each telescoping section includes a transverse tubular arm attached to its distal end, with the transverse arm having an opening sized to receive the support arm. For example, a section of square tubular bar may be welded to the distal end of each telescoping section.

Preferably, the base sections, telescoping sections and support bar is constructed of square tubular metal, e.g., steel or aluminum, with the outer diameter of the base sections corresponding to the inner diameters of the telescoping sections. The outer diameter of the support bar corresponds to the inner diameter of the transverse openings in the distal ends of the telescoping sections.

Assembly and use of the bed extender is quick and simple, and requires no tools other than to attach the mounting brackets to the pickup bed walls. First, the mounting brackets are attached, e.g., by bolting, adjacent the intersection of the bed floor, bed wall and tail gate. Preferably, the mounting brackets are attached to the bed walls adjacent the rear edge of the bed floor. However, each mounting bracket may alternatively be attached to the bed floor adjacent a wall and the rear edge of the bed floor. In either event; the mounting bracket will include a transverse, horizontal bore for pivotal attachment of a base tubular section.

The mounting brackets may remain attached to the truck bed, i.e., not unbolted after use. Normal use of the truck bed is not affected by the brackets, since the brackets only extend inwardly about 2 inches. The remaining components of the bed extender can be readily detached after use or pivoted into the truck bed for storage.

To assemble the bed extender, the base tubular sections are pivotally attached to the mounting posts by simply sliding the transverse posts into the mounting bracket bores. The telescoping sections are slid onto the distal ends of the base sections and secured at the desired telescoped extension.

The support bar is then inserted through the transverse, horizontal openings in the distal ends of the telescoping sections by first inserting an end of the support bar through one telescoping section opening from the exterior side of the opening and continuing to insert the support section until the end of the support section extends through the opening in the other telescoping sections. The support bar and telescoping sections are then secured together.

Note that assembly only requires insertion of the base section posts into bracket bores, insertion of the telescoping sections onto the base sections, and insertion of the transverse support bar into the openings in the telescoping sections. This assembly is quick, simple and does not require tools. Disassembly is equally quick and simple, merely requiring a reversal of the above steps when the bed extender is no long needed.

Note also that the present bed extender is independent of the width of the truck bed. The mounting sections are simply attached to the bed walls or at the sides of the bed floor adjacent the bed walls and the rear of the bed floor in any width truck bed. The differences in bed width are taken into account by the sliding support section which is attachable at different points relative to the spacing of the telescoping sections.

When used to support long items, the bed extender is used in a horizontal position with the tailgate in its lowered, horizontal position, so that the bed extender rests on the tailgate. If desired, the apparatus can also include releasible attachment brackets to secure the bed extender to the tailgate.

Since the base tubular sections are pivotally attached to the mounting sections, the bed extender can also be used in a vertical orientation with the tailgate closed. In this position, longer items can extend at an upward angle from the front of the truck bed and rest on the horizontal support bar instead of extending horizontally from the rear of the bed. In this orientation, the extender can also be used to support the rear of ladders and other long items with the front of the item being supported by a front support, which maybe a rack on top of the truck cab, or a separate support rack attached to the front wall of the pickup truck bed. The bed extender can also be pivoted forward to a horizontal position where it rests on the bed floor.

The bed extender can also include a cover plate, such as a rectangular metal or wooden plate, attachable to the upper surfaces of the bed extender to enable carrying of smaller items. The plate can also be used as a work surface.

### BRIEF DESCRIPTION OF THE DRAWINGS

FIG. 1 is a top view of a pickup truck with the bed extender mounted in the truck bed in the horizontal position.

FIG. 2 is a top view of a pickup truck with the bed extender pivoted forward to rest horizontally on the truck bed floor.

FIG. 3 is a sectional side view of a pickup truck with the bed extender mounted in the truck bed in the rearward horizontal position.

FIG. 4 is a sectional side view of a pickup truck with the bed extender mounted in the truck bed in the vertical position, and a front support rack attached to the truck bed front wall.

FIG. 5 is a perspective view of the individual components of the bed extender.

### DETAILED DESCRIPTION OF THE INVENTION

In the following description, terms such as horizontal, upright, vertical, above, below, beneath, and the like, are used solely for the purpose of clarity in illustrating the invention, and should not be taken as words of limitation. The drawings are for the purpose of illustrating the invention and are not intended to be to scale.

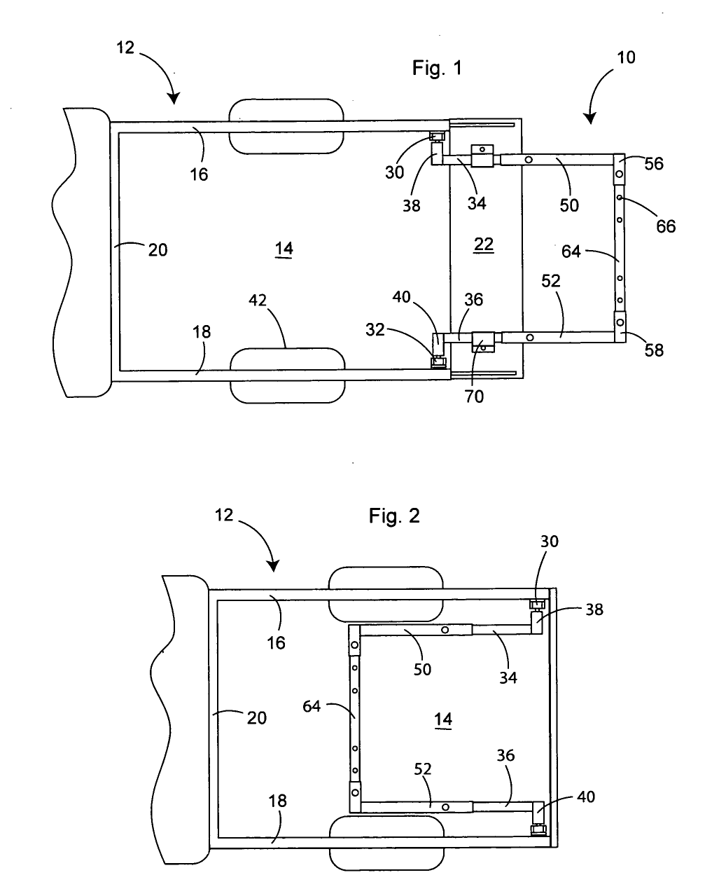

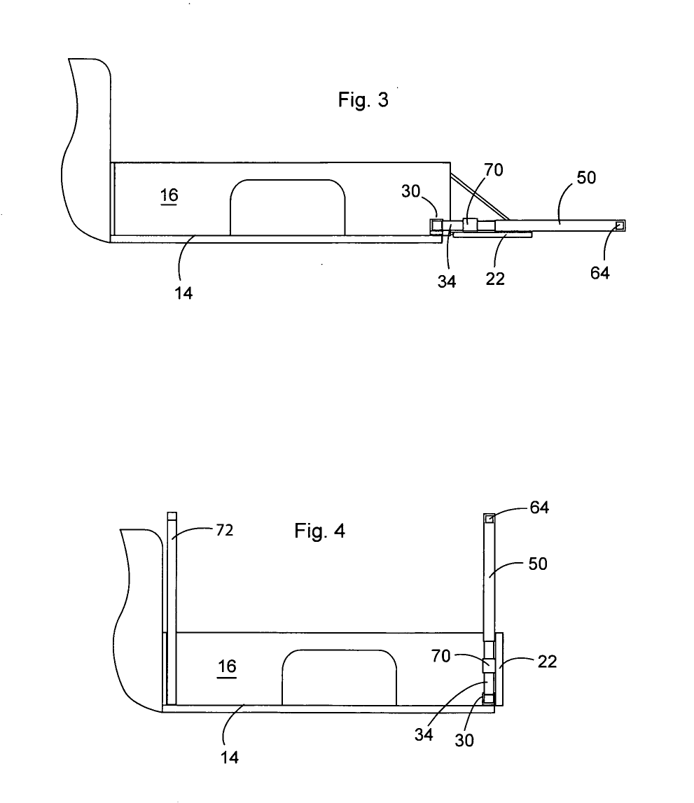

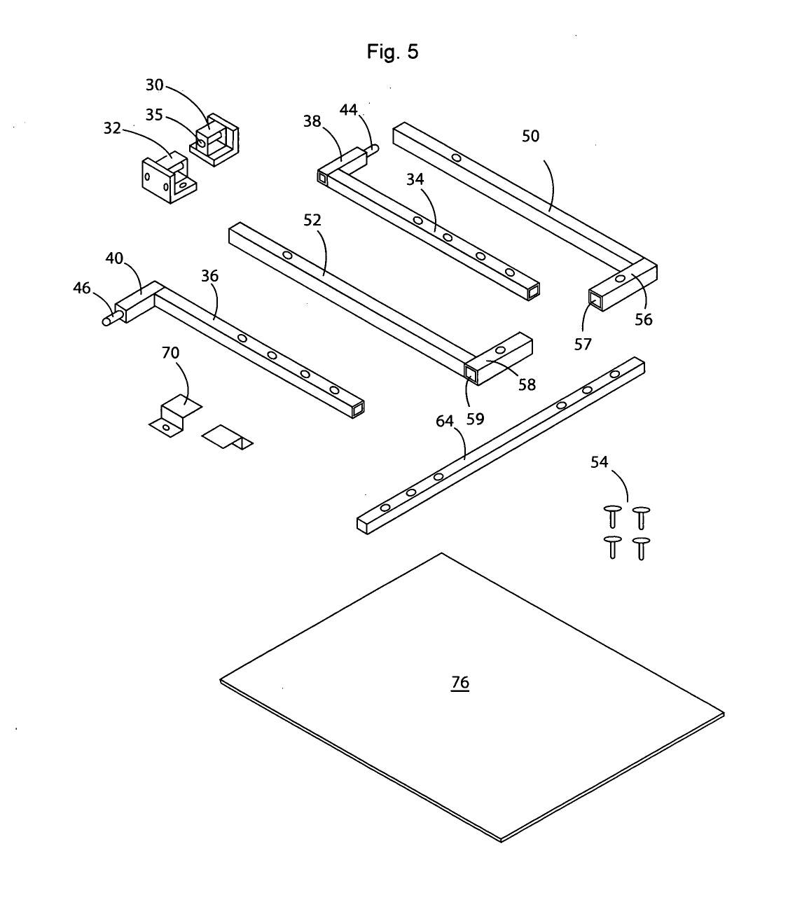

FIGS. 1-4 illustrate a preferred embodiment of bed extender, generally 10, mounted in pickup truck bed, generally 12. Bed 12 includes bed floor 14, side walls 16 and 18, front wall 20, and tailgate 22 hinged at its lower edge to the rear edge of bed floor 14. Tailgate 22 is moveable between a rearward horizontal position resting on tailgate 22 as illustrated in FIGS. 1 and 3, a forward horizontal position resting on bed floor 14 as illustrated in FIG. 2, and a vertical position as illustrated in FIG. 3.

Bed extender 10 is comprised of mounting brackets 30 and 32 shown attached to side walls 16 and 18, respectively. Each bracket includes a horizontal, transverse, cylindrical mounting bore 34.

To minimize interference with other uses of the truck bed, to maximize the extension of bed extender 10, and to provide a bed extender 10 that is oriented horizontally when tailgate 22 is in the lowered position, brackets 30 and 32 are mounted at or adjacent the rear of bed floor 14, whereby extender 10 will rest horizontally against bed floor 14 when in the forward orientation and horizontally against tailgate 22 when in the rearward orientation with tailgate 22 is in its lowered position.

Base tubular sections 34 and 36 include outwardly extending transverse spacer arms 38 and 40 having a length sufficient to allow bed extender 10 to pivot to a horizontal position between wheel wells 42, i.e., spacer arms 38 will have a length approximately equal to the width of wheel wells 42 inside bed 12. Arms 38 and 40 include cylindrical pins 44 and 46, respectively, at their outer ends sized for insertion onto bores 34. When mounted, sections 34 and 36 are pivotal along a 180° arc from a rearward horizontal position to a forward horizontal position. Sections 34 and 36 also include spaced alignment holes in their upper walls. Preferably, sections 34 and 36 have a square tubular cross section.

Telescoping sections 50 and 52 are sized for sliding insertion over base sections 34 and 36 between a fully inserted position and a fully extended position. Sections 50 and 52 include alignment holes on their upper walls that can be selectively aligned with an alignment hole in a base section. A locking pin 54 can then be used to lock sections 50 and 52 to sections 34 and 36 together in the desired extension.

The distal ends of sections 50 and 52 include inwardly extending tubular support mounting arms 56 and 58, respectively. Each arm includes an alignment hole 60. Elongated support bar 64 is sized to extend through arms 56 and 58. Support bar 64 includes alignment holes 66 for selective alignment with alignment holes 60 to secure member 64 to arms 56 and 58.

Optionally, bed extender 10 may also include tailgate brackets 70 to releasibly attach bed extender 10 to the inner wall of tailgate 22, providing greater stability. Brackets 60 can also be used to hold bed extender 10 in the vertical position as shown in FIG. 4. The exact configuration of brackets 70 is not critical, so long as the brackets secure extender 10 and are readily removable when uninstalling extender 10. A vertical support rack 72 may be mounted at front wall 74 so that items can be supported horizontally on bar 64 and rack 72.

Bed extender 10 may also include rectangular cover plate 76, sized to fit onto the upper walls of bed extender 10 when extender 10 is in the horizontal position as shown in FIGS. 1-2. Plate may be of metal or wood, e.g., plywood or MDF. Plate may be attached with bolts or other suitable means, not shown.

Mounting brackets 30 and 32 may be removed when bed extender is not being used. Normally, however, bracket 30 and 32 will remain attached to walls 16 and 18, or to floor 14, since their presence does not interfere with other uses of the truck bed. Bed extender 10 is mounted by attaching base sections 34 and 36 to brackets 30 and 32 by sliding the transverse posts 44 and 46 into bores 34. Sections 40 and 42 are telescoped onto base sections 34 and 36 and secured at the desired extension.

Support bar 64, preferably a square tubular bar, is inserted through the openings in tubular arms 56 and 58 and secured to arms 56 and 58. Bed extender 10 is then pivoted to the rearward horizontal orientation or vertical orientation for use, or pivoted to the forward horizontal orientation on bed floor 14 for storage. Tailgate brackets 70 may be used to secure bed extender 10 to tailgate 22. If used in the rearward horizontal orientation, plate 76 may be attached to the upper walls of extender 10. The bed extender is now ready for use, with support member 64 supporting projecting lumber, ladders or other items.

Certain modifications and improvements will occur to those skilled in the art upon a reading of the foregoing description. It should be understood that all such modifications and improvements have been deleted herein for the sake of conciseness and readability but are properly within the scope of the following claims.

1. A truck bed extender for use with a pickup truck having a bed with a bed floor, opposed side walls along each side of the bed floor, and a tailgate hinged at the rear of the bed floor comprising:
a) mounting brackets at each side of the bed adjacent the rear of said bed floor;
b) first and second tubular base sections having proximal ends pivotally attached to the mounting brackets, said base sections having distal ends;
c) first and second tubular telescoping sections telescopically attached to said base sections, said telescoping sections having distal ends and being telescopic to selected positions between a fully inserted position and a fully extended position; and
d) a support bar extending transversely between the distal ends of said telescoping sections, said telescoping sections include tubular transverse arms with transverse openings at their distal ends, said support bar extending through said transverse openings.

2. The truck bed extender of claim 1, wherein said mounting brackets are mounted on the bed side walls.

3. The truck bed extender of claim 1, wherein said mounting brackets are mounted on the bed floor.

4. (canceled)

5. The truck bed extender of claim 1, wherein said base sections include transverse outwardly extending posts at their proximal ends, and said mounting brackets include transverse bores to receive said posts.

6. (canceled)

7. The truck bed extender of claim 1, further including tailgate mounting brackets attachable to the inner side of said tailgate and to said bed extender.

8. The truck bed extender of claim 1, wherein said base sections include outwardly extending transverse spacer arms at their proximal ends, said brackets being pivotally attached at the distal ends of said spacer arms.

9. The truck bed extender of claim 1, wherein said bed extender is pivotal between a rearward horizontal orientation against said tailgate when said tailgate is in its lowered position and a forward horizontal orientation against said bed floor.

10. A truck bed extender for use with a pickup truck having a bed with a bed floor, opposed side walls along each side of the bed floor and a tailgate hinged at the rear of the bed floor comprising:
a) mounting brackets attached to said side walls, said brackets including inwardly extending posts;
b) first and second tubular base sections having proximal ends pivotally attached on said posts, said base sections having distal ends;
c) first and second tubular telescoping sections telescopically attached to said base sections, said telescoping sections having distal ends with transverse openings; and
d) a support bar extending through the openings in the distal ends of said telescoping sections.

11. The truck bed extender of claim 10, wherein said mounting brackets are adjacent the tailgate of said truck bed.

12. The truck bed extender of claim 10, wherein the distal ends of the telescoping sections include tubular transverse arms at their distal ends, the support bar being insertable through said arms.

13. The truck bed extender of claim 10, further including tailgate mounting brackets attachable to the inner side of said tailgate and to said bed extender.

14. The truck bed extender of claim 10, further including a platform attachable to said telescoping bed extender.

15. A truck bed extender for use with a pickup truck having a bed with a bed floor, opposed side walls along each side of the bed floor and a tailgate hinged at the rear of the bed floor comprising:
a) mounting brackets attached to said side walls adjacent said bed floor and tailgate, said brackets including transverse bores;
b) first and second tubular base sections having proximal ends with outwardly extending transverse posts pivotally insertable into said bores, said base sections having distal ends;
c) first and second tubular telescoping sections telescopically attached to said base sections, said telescoping sections having transverse arms with horizontal openings at their distal ends; and
d) a support bar extending through the openings in said arms.

16. The truck bed extender of claim 15, further including tailgate mounting brackets attachable to the inner side of said tailgate and to said bed extender.

17. The truck bed extender of claim 15, further including a platform attachable to said telescoping bed extender.

18. The truck bed extender of claim 15, wherein said sections and arm are constructed of square tubing.

19. The truck bed extender of claim 15, further including locking means to secure said base sections to said telescoping sections at desired extensions.

20. The truck bed extender of claim 15, further including locking means to secure said support bar to said arms.
